(19) United States
(12) Patent Application Publication
(10) Pub. No.: US 2016/0269545 A1
(43) Pub. Date: Sep. 15, 2016

(54) ELECTRONIC DEVICE AND METHOD FOR MANAGING DATA THEREOF

(71) Applicant: Samsung Electronics Co., Ltd., Gyeonggi-do (KR)

(72) Inventors: Yongwoo LEE, Gyeonggi-do (KR); Min Sung EO, Gyeonggi-do (KR)

(21) Appl. No.: 15/059,846

(22) Filed: Mar. 3, 2016

(30) Foreign Application Priority Data
Mar. 10, 2015 (KR) 10-2015-0033288

(51) Int. Cl. H04M 1/725; H04W 52/02

(52) U.S. Cl. CPC H04M 1/72583; H04W 52/0229; H04M 1/72547

(57) ABSTRACT

A method of an electronic device comprising: receiving, by a communication module of the electronic device, data from outside of the electronic device; identifying, by the communication module, a filtering condition associated with the data; detecting, by the communication module, whether the filtering condition is satisfied; and forwarding, by the communication module, the data to inside of the electronic device in response to detecting that the filtering condition is satisfied.

### CLAIM OF PRIORITY

This application claims the benefit under 35 U.S.C. §119(a) of a Korean patent application filed in the Korean Intellectual Property Office on Mar. 10, 2015 and assigned Serial No. 10-2015-0033288, the entire disclosure of which is hereby incorporated by reference.

### BACKGROUND

1. Field of the Disclosure

The present disclosure relates electronic devices, in general, and more particularly to an apparatus and method for managing data.

2. Description of the Related Art

An electronic device may perform various functions to provide various services. In addition, the electronic device may manage data generated during the functions are executed. Recently, the electronic device may drive an application installed therein to provide the service. In this case, the electronic device may receive data from a server in association with the application. Herein, the data (e.g., a push message) may indicate new information associated with the application. That is, the server may transmit the data to the electronic device at a determined time or in association with data generation. In other words, the server may transmit the data to the electronic device without a request of the electronic device. Further, the electronic device may perform reporting of the data.

The electronic device may wake up from a sleep mode in association with data reception. Upon receiving data in the sleep mode, the electronic device may wake up and enter an active mode. In this case, in the electronic device, current consumed in the sleep mode and current consumed in the active mode may be different from each other. Accordingly, there may be a problem in that current consumption of the electronic device is increased when the electronic device receives data in the sleep mode. The problem may become more serious in the electronic device when the number of times of receiving the data in the sleep mode is increased.

### SUMMARY

According to aspects of the disclosure, a method of an electronic device is provided comprising: receiving, by a communication module of the electronic device, data from outside of the electronic device; identifying, by the communication module, a filtering condition associated with the data; detecting, by the communication module, whether the filtering condition is satisfied; and forwarding, by the communication module, the data to inside of the electronic device in response to detecting that the filtering condition is satisfied.

According to aspects of the disclosure, an electronic device is provided comprising: at least one processor; and processor communication module operatively coupled to the memory, configured to: receive data from outside of the electronic device, identify a filtering condition associated with the data, detect whether the filtering condition is satisfied, and forward the data to the at least one processor in response to detecting that the filtering condition is satisfied.

### BRIEF DESCRIPTION OF THE DRAWINGS

The above and other aspects, features and advantages of certain embodiments of the present disclosure of the present disclosure will be more apparent from the following detailed description taken in conjunction with the accompanying drawings, in which:

FIG. 1 is a diagram of an example of a network environment, according to various embodiments of the present disclosure;

FIG. 2 is a block diagram of an example of an electronic device, according to various embodiments of the present disclosure;

FIG. 3 is a block diagram of an example of a program module, according to various embodiments of the present disclosure;

FIG. 4 is a block diagram of an example of an electronic device, according to various embodiments of the present disclosure;

FIG. 5 is a sequence diagram of an example of a process, according to various embodiments of the present disclosure;

FIG. 6A is a diagram of an example of a user interface, according to various embodiments of the present disclosure;

FIG. 6B is a diagram of an example of a user interface, according to various embodiments of the present disclosure;

FIG. 7A is a diagram of an example of a user interface, according to various embodiments of the present disclosure;

FIG. 7B is a diagram of an example of a user interface, according to various embodiments of the present disclosure;

FIG. 8A is a diagram of an example of a user interface, according to various embodiments of the present disclosure;

FIG. 8B is a diagram of an example of a user interface, according to various embodiments of the present disclosure;

FIG. 9A is a diagram of an example of a user interface, according to various embodiments of the present disclosure;

FIG. 9B is a diagram of an example of a user interface, according to various embodiments of the present disclosure;

FIG. 10A is a diagram of an example of a user interface, according to various embodiments of the present disclosure;

FIG. 10B is a diagram of an example of a user interface, according to various embodiments of the present disclosure;

FIG. 11A is a diagram of an example of a user interface, according to various embodiments of the present disclosure;

FIG. 11B is a diagram of an example of a user interface, according to various embodiments of the present disclosure;

FIG. 12 is a flowchart of an example of a process, according to various embodiments of the present disclosure;

FIG. 13A is a flowchart of a portion of a process, according to various embodiments of the present disclosure;

FIG. 13B is a flowchart of a portion of a process, according to various embodiments of the present disclosure; and

FIG. 13C is a flowchart of a portion of a process, according to various embodiments of the present disclosure

### DETAILED DESCRIPTION

Exemplary embodiments of the present disclosure will be described hereinbelow with reference to the accompanying drawings. However, the examples provided throughout the disclosure are not limited to the specific embodiments and should be construed as including modification, equivalent and/or alternative of embodiments of the present disclosure. In the explanation of the drawings, similar reference numerals are used for similar elements.

The terms “have,” “may have,” “include,” and “may include” used in the embodiments of the present disclosure indicate the presence of corresponding features (for example, elements such as numerical values, functions, operations, or parts), and do not preclude the presence of additional features.

The terms “A or B,” “at least one of A or/and B,” or “one or more of A or/and B” used in the embodiments of the present disclosure include all possible combinations of items enumerated with them. For example, “A or B,” “at least one of A and B,” or “at least one of A or B” means (1) including at least one A, (2) including at least one B, or (3) including both at least one A and at least one B.

The terms such as “first” and “second” used throughout the disclosure may modify various elements regardless of an order and/or importance of the corresponding elements, and does not limit the corresponding elements. These terms may be used for the purpose of distinguishing one element from another element. For example, a first user device and a second user device may indicate different user devices regardless of the order or importance. For example, a first element may be named a second element without departing from the scope of various embodiments of the present disclosure, and similarly, a second element may be named a first element.

It will be understood that, when an element (for example, a first element) is “(operatively or communicatively) coupled with/to” or “connected to” another element (for example, a second element), the element may be directly coupled with/to another element, and there may be an intervening element (for example, a third element) between the element and another element. To the contrary, it will be understood that, when an element (for example, a first element) is “directly coupled with/to” or “directly connected to” another element (for example, a second element), there is no intervening element (for example, a third element) between the element and another element.

The expression “configured to (or set to)” used throughout the present disclosure may be replaced with “suitable for,” “having the capacity to,” “designed to,” “adapted to,” “made to,” or “capable of” according to a context. The term “configured to (set to)” does not necessarily mean “specifically designed to” at the hardware level. Instead, the expression “apparatus configured to . . . ” may mean that the apparatus is “capable of . . . ” along with other devices or parts in a certain context. For example, “a processor configured to (set to) perform A, B, and C” may mean a dedicated processor (e.g., an embedded processor) for performing a corresponding operation, or a generic-purpose processor (e.g., a CPU or an application processor) capable of performing a corresponding operation by executing one or more software programs stored in a memory device.

The terms used in the various embodiments of the present disclosure are just for the purpose of describing particular embodiments and are not intended to limit the present disclosure. As used herein, the singular forms are intended to include the plural forms as well, unless the context clearly indicates otherwise. All of the terms used herein including technical or scientific terms have the same meanings as those generally understood by an ordinary skilled person in the related art unless they are defined otherwise. The terms defined in a generally used dictionary should be interpreted as having the same or similar meanings as or to the contextual meanings of the relevant technology and should not be interpreted as having ideal or exaggerated meanings unless they are clearly defined. According to circumstances, even the terms defined in the embodiments should not be interpreted as excluding the embodiments of the present disclosure.

An electronic device according to various embodiments of the present disclosure may include at least one of a smartphone, a tablet personal computer (PC), a mobile phone, a video phone, an electronic book reader, a desktop PC, a laptop PC, a netbook computer, a workstation, a server, a Personal Digital Assistant (PDA), a Portable Multimedia Player (PMP), an MP3 player, a mobile medical machine, a camera, or a wearable device (for example, smart glasses, a head-mounted-device (HMD), electronic clothing, an electronic bracelet, an electronic necklace, an electronic appcessory, electronic tattoos, a smart mirror, or a smart watch).

According to embodiments of the present disclosure, the electronic device may be a smart home appliance. For example, the smart home appliance may include at least one of a television, a Digital Video Disk (DVD) player, a stereo, a refrigerator, an air conditioner, a cleaner, an oven, a microwave oven, a washing machine, an air cleaner, a set-top box, a home automation control panel, a security control panel, a TV box (for example, Samsung HomeSync™, Apple TV™, or Goggle TV™), a game console (for example, Xbox™, PlayStation™), an electronic dictionary, an electronic key, a camcorder, or an electronic album.

According to another exemplary embodiment, the electronic device may include at least one of various medical machines (for example, various portable medical measurement devices (a glucose monitor, a heart rate monitor, a blood pressure measuring device, or a thermometer), Magnetic Resonance Angiography (MRA), Magnetic Resonance Imaging (MRI), Computerized Tomography (CT), a tomograph, an ultrasound machine, and the like), a navigation device, a Global Positioning System (GPS) receiver, an Event Data Recorder (EDR), a Flight Data Recorder (FDR), an automotive infotainment device, electronic equipment for ship (for example, a navigation equipment for ship, a gyro compass, and the like), avionics, a security device, a head unit for vehicles, an industrial or home robot, an automatic teller machine (ATM) of a financial institution, point of sales (POS) of a store, or Internet of Things (for example, a lamp, various sensors, an electric or gas meter, a sprinkler, a fire alarm, a thermostat, a streetlamp, a toaster, an exercising machine, a hot water tank, a heater, a boiler, etc.).

According to an exemplary embodiment, the electronic device may include at least one of a part of furniture or a building/a structure, an electronic board, an electronic signature receiving device, a projector, and various measurement devices (for example, devices for measuring water, power, gas, radio waves, and the like). The electronic device according to various embodiments may be one or a combination of one or more of the above-mentioned devices. In addition, the electronic device according to various embodiments may be a flexible electronic device. In addition, the electronic device, according to various embodiments, is not limited to the above-mentioned devices, and may include a new electronic device accompanied by technology development.

Hereinafter, an electronic device according to various embodiments will be explained with reference to the accompanying drawings. The term “user” used in the various embodiments may refer to a person who uses the electronic device or a device that uses the electronic device (for example, an artificial intelligence electronic device).

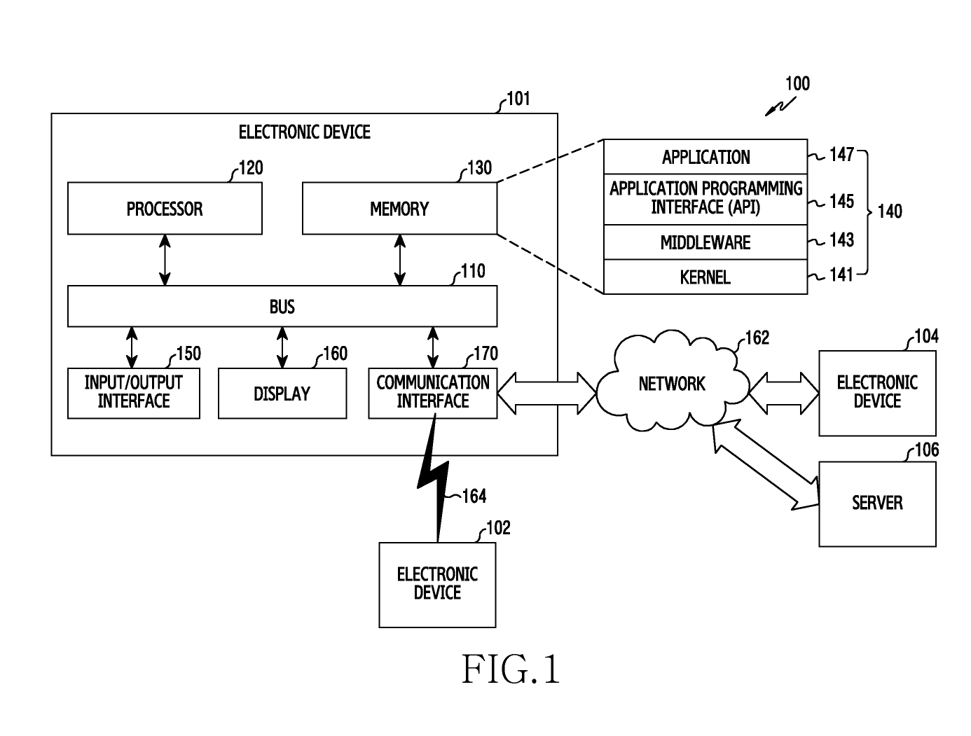

FIG. 1 is a diagram of an example of a network environment, according to various embodiments of the present disclosure.

Referring to FIG. 1, the electronic device 101 in the network environment 100 according to various embodiments of the present disclosure will be described. The electronic device 101 may include a bus 110, a processor 120, a memory 130, an input and output interface 150, a display 160, and a communication interface 170. According to an exemplary embodiment, the electronic device 101 may omit at least one of the elements or may include additional other elements.

The bus 110 may include a circuit which connects the elements 110-170 with one another and transmits communications (for example, a control message and/or data) between the elements.

The processor 120 may include any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), etc. Additionally or alternatively, according to various embodiments of the present disclosure, the processor 120 may include one or more of a central processing unit (CPU), an application processor (AP), or a communication processor (CP). The processor 120 may execute calculation or data processing related to control and/or communication of at least one other element of the electronic device 101.

The memory 130 may include any suitable type of volatile or non-volatile memory, such as Random-access Memory (RAM), Read-Only Memory (ROM), Network Accessible Storage (NAS), cloud storage, a Solid State Drive (SSD), etc. For example, the memory 130 may store instructions or data which is related to at least one other element of the electronic device 101. According to an exemplary embodiment, the memory 130 may store software and/or a program 140. For example, the program 140 may include a kernel 141, middleware 143, an Application Programming Interface (API) 145, and/or an application program (e.g., an application) 147, and the like. At least some of the kernel 141, the middleware 143, or the API 145 may be referred to as an operating system (OS).

For example, the kernel 141 may control or manage system resources (for example, the bus 110, the processor 120, the memory 130, and the like) which are used for performing operations or functions implemented in the other programs (for example, the middleware 143, the API 145, or the application 147). In addition, the kernel 141 may provide an interface for allowing the middleware 143, the API 145, or the application program 147 to access an individual element of the electronic device 101 and control or manage the system resources.

For example, the middleware 143 may serve as an intermediary to allow the API 145 or the application program 147 to communicate with the kernel 141 and exchange data with the kernel 141.

In addition, the middleware 143 may process one or more operation requests received from the application program 147 according to priority. For example, the middleware 143 may give priority for using the system resources of the electronic device 101 (for example, the bus 110, the processor 120, the memory 130, and the like) to at least one of the application programs 147. For example, the middleware 143 may perform scheduling or load balancing with respect to the one or more operation requests by processing the one or more operation requests according to the priority given to the at least one application program.

For example, the API 145 may be an interface for allowing the application 147 to control a function provided by the kernel 141 or the middleware 143, and, for example, may include at least one interface or function (for example, instructions) for controlling a file, controlling a window, processing an image, or controlling a text.

For example, the input and output interface 150 may serve as an interface for transmitting instructions or data inputted from a user or another external device to other element(s) of the electronic device 101. In addition, the input and output interface 150 may output instructions or data received from other element(s) of the electronic device 101 to the user or another external device.

For example, the display 160 may include a liquid crystal display (LCD), a light-emitting diode (LED) display, an organic light-emitting diode (OLED) display, or a microelectromechanical system (MEMS) display, or an electronic paper display. The display 160 may display various contents (for example, a text, an image, a video, an icon, a symbol, etc.) for the user. The display 160 may include a touch screen, and for example, may receive input of a touch using an electronic pen or a part of a user's body, a gesture, approach, or hovering.

For example, the communication interface 170 may establish communication between the electronic device 101 and an external device (for example, a first external electronic device 102, a second external electronic device 104, or a server 106). For example, the communication interface 170 may be connected to a network 162 via wireless communication or wire communication to communicate with the external device (for example, the second external electronic device 104, or the server 106).

The wireless communication may use, as a cellular communication protocol, at least one of Long Term Evolution (LTE), LTE-Advance (LTE-A), Code Division Multiple Access (CDMA), Wideband CDMA (WCDMA), Universal Mobile Telecommunications System (UMTS), Wireless Broadband (WiBro), or Global System for Mobile Communications (GSM), etc. In addition, for example, the wireless communication may include short-distance communication 164. For example, the short-distance communication 164 may include at least one of Wireless Fidelity (WiFi), Bluetooth, Near Field Communication (NFC), GPS, etc. The wire communication may include at least one of a Universal Serial Bus (USB), a High-Definition Multimedia Interface (HDMI), a Recommended Standard 232 (RS-232), or plain old telephone service (POTS). The network 162 may include a telecommunications network, for example, at least one of a computer network (for example, a LAN or WAN), the Internet, or a telephone network.

Each of the first external electronic device 102 and the second external electronic device 104 may be the same kind of electronic device as the electronic device 101 or a different kind of device. According to an exemplary embodiment, the server 106 may include a group of one or more servers. According to various embodiments, all or a part of the operations executed in the electronic device 101 may be executed in another electronic device or a plurality of other electronic devices (for example, the electronic devices 102, 104 or the server 106). According to an exemplary embodiment, when the electronic device 101 should perform a certain function or service automatically or in response to a request, the electronic device 101 may request another device (for example, the electronic devices 102, 104 or the server 106) to perform at least some function related to the certain function or service additionally or instead of executing the function or service by itself. Another electronic device (for example, the electronic devices 102, 104 or the server 106) may execute the requested function or additional function, and transmit the result to the electronic device 101. The electronic device 101 may process the received result as it is or additionally, and provide the requested function or service. To achieve this, cloud computing, distributed computing, or client-server computing technology may be used, for example.

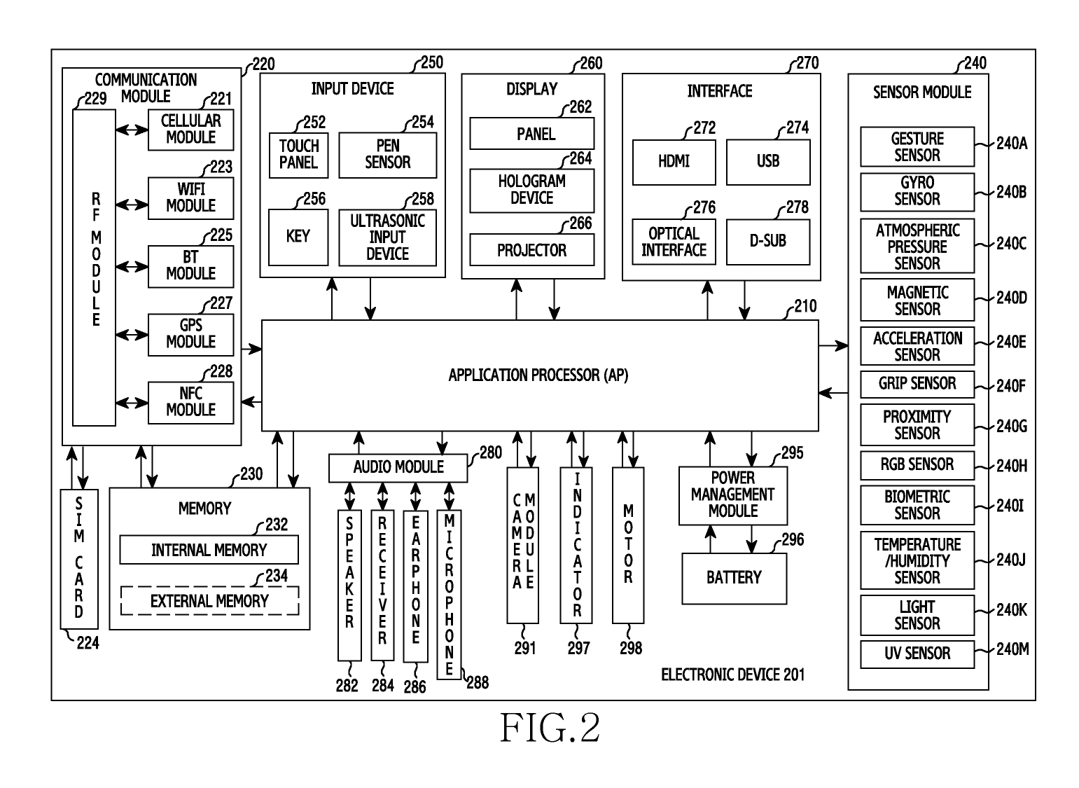

FIG. 2 is a block diagram of an example of an electronic device, according to various embodiments of the present disclosure. For example, the electronic device 201 may include an entirety or part of the electronic device 101 shown in FIG. 1.

Referring to FIG. 2, the electronic device 201 may include one or more processors 210 (for example, an Application Processors (AP)), a communication module 220, a Subscriber Identification Module (SIM) 224, a memory 230, a sensor module 240, an input device 250, a display 260, an interface 270, an audio module 280, a camera module 291, a power management module 295, a battery 296, an indicator 297, or a motor 298.

The processor 210 may control a plurality of hardware or software elements connected to the processor 210 by driving an operating system or an application program, and may process and calculate various data. For example, the processor 210 may be implemented by using a System on Chip (SoC). According to an exemplary embodiment, the processor 210 may further include a Graphic Processing Unit (GPU) and/or an image signal processor. The processor 210 may include at least part of the elements shown in FIG. 2 (for example, the cellular module 221). The processor 210 may load instructions or data received from at least one of the other elements (for example, a non-volatile memory) into a volatile memory and process the instructions or data, and may store various data in the non-volatile memory.

The communication module 220 may have a same or similar configuration as or to that of the communication interface 170 of FIG. 1. For example, the communication module 220 may include the cellular module 221, a WiFi module 223, a BT module 225, a GPS module 227, an NFC module 228, and a Radio Frequency (RF) module 229.

The cellular module 221 may provide a voice call, a video call, a text service, or an internet service through a telecommunications network. According to an exemplary embodiment, the cellular module 221 may identify and authenticate the electronic device 201 in the telecommunications network by using the subscriber identification module 224 (for example, an SIM card). According to an exemplary embodiment, the cellular module 221 may perform at least some of the functions provided by the processor 210. According to an exemplary embodiment, the cellular module 221 may include a communication processor (CP).

The WiFi module 223, the BT module 225, the GPS module 227, or the NFC module 228 each may include a processor for processing data received and transmitted through a corresponding module. According to an exemplary embodiment, at least some (for example, two or more) of the cellular module 221, the WiFi module 223, the BT module 225, the GPS module 227, or the NFC module 228 may be included in a single integrated chip (IC) or a single IC package.

The RF module 229 may transmit and receive communication signals (for example, RF signal). For example, the RF module 229 may include a transceiver, a Power Amp Module (PAM), a frequency filter, a Low Noise Amplifier (LNA), an antenna, etc. According to another exemplary embodiment, at least one of the cellular module 221, the WiFi module 223, the BT module 225, the GPS module 227, or the NFC module 228 may transmit and receive an RF signal by using a separate RF module.

The subscriber identification module 224 may include a card and/or an embedded SIM including the subscriber identification module, and may include its unique identification information (for example, an Integrated Circuit Card Identifier (ICCID)) or subscriber information (for example, International Mobile Subscriber Identity (IMSI)).

The memory 230 (for example, the memory 130) may include an internal memory 232 or an external memory 234. For example, the internal memory 232 may include at least one of a volatile memory (for example, a Dynamic Random Access Memory (DRAM), a Static Random Access Memory (SRAM), a Synchronous DRAM (SDRAM), and the like) and a non-volatile memory (for example, an One-Time Programmable Read-Only Memory (OTPROM), a Programmable Read-Only Memory (PROM), an Erasable Programmable Read-Only Memory (EPROM), an Electrically Erasable Programmable Read-Only Memory (EEPROM), a mask ROM, a flash ROM, a flash memory (for example, a NAND flash memory, a NOR flash memory, and the like), a hard drive, a solid state drive (SSD).

For example, the external memory 234 may further include a flash drive, for example, Compact Flash (CF), Secure Digital (SD), Micro-SD, Mini-SD, extreme-Digital (xD), a Multi Media Card (MMC), memory stick, and the like. The external memory 234 may be functionally and/or physically connected to the electronic device 201 through various interfaces.

The sensor module 240 may measure a physical quantity or detect an operation state of the electronic device 201, and may convert measured or detected information into electric signals. The sensor module 240 may include at least one of a gesture sensor 240A, a gyro sensor 240B, a barometric pressure sensor 240C, a magnetic sensor 240D, an acceleration sensor 240E, a grip sensor 240F, a proximity sensor 240G, a color sensor 240H (e.g., Red, Green, Blue (RGB) sensor), a biosensor 240I, a temperature/humidity sensor 240J, an illumination sensor 240K, and a Ultraviolet (UV) sensor 240M. Additionally or alternatively, the sensor module 240 may include an E-nose sensor (not shown), an electromyography (EMG) sensor (not shown), an electroencephalogram (EEG) sensor (not shown), an electrocardiogram (ECG) sensor (not shown), an infrared ray (IR) sensor, an iris sensor (not shown), and/or a fingerprint sensor (not shown), and the like. The sensor module 240 may further include a control circuit to control at least one sensor included therein. According to an exemplary embodiment, the electronic device 201 may further include a processor configured to control the sensor module 240 as a part of the processor 210 or a separate part, and may control the sensor module 240 while the processor 210 is in a sleep state.

The input device 250 may include a touch panel 252, a (digital) pen sensor 254, a key 256, or an ultrasonic input device 258. The touch panel 252 may use at least one method of capacitive, resistive, infrared, and ultrasonic methods. In addition, the touch panel 252 may further include a control circuit. The touch panel 252 may further include a tactile layer to provide a tactile response to the user.

The (digital) pen sensor 254 may be a part of the touch panel or may include a separate detection sheet. The key 256 may include a physical button, an optical key, or a keypad. The ultrasonic input device 258 may detect ultrasonic waves generated in an input tool through a microphone (for example, the microphone 288), and identify data corresponding to the detected ultrasonic waves.

The display 260 (e.g., the display 160) may include a panel 262, a hologram device 264, or a projector 266. The panel 262 may have a same or similar configuration as or to that of the display 160 of FIG. 1. For example, the panel 262 may be implemented to be flexible, transparent, or wearable. The panel 262 may be configured as a single module along with the touch panel 252. The hologram device 264 may show a stereoscopic image in the air using interference of light. The projector 266 may display an image by projecting light onto a screen. The screen may be located inside or outside the electronic device 201. According to an exemplary embodiment, the display 260 may further include a control circuit to control the panel 262, the hologram device 264, or the projector 266.

The interface 270 may include a High Definition Multimedia Interface (HDMI) 272, a Universal Serial Bus (USB) 274, an optical interface 276, or D-subminiature (sub) 278. The interface 270 may be included in the communication interface 170 shown in FIG. 1. Additionally or alternatively, the interface 270 may include a Mobile High Definition Link (MHL) interface, a Secure Digital (SD) card/Multimedia Card (MMC) interface or Infrared Data Association (IrDA) standard interface.

The audio module 280 may convert a sound and an electric signal bidirectionally. For example, at least some elements of the audio module 280 may be included in the input and output interface 150 shown in FIG. 1. The audio module 280 may process sound information which is input or output through a speaker 282, a receiver 284, an earphone 286, or a microphone 288.

The camera module 291 is a device for photographing a still image and a moving image, and, according to an exemplary embodiment, the camera module 291 may include one or more image sensors (for example, a front surface sensor or a rear surface sensor), a lens, an Image Signal Processor (ISP), or a flash (for example, a Light Emitting Diode (LED) or a xenon lamp).

essor 210 is in a sleep stat 295 may manage the power supply of the electronic device 201. According to an exemplary embodiment, the power management module 295 may include a Power Management IC (PMIC), a charger IC, or a battery or fuel gauge. For example, the PMIC may have a wire charging method and/or a wireless charging method. The wireless charging method may include a magnetic resonance method, a magnetic induction method, or an electromagnetic wave method, and an additional circuit for charging wirelessly, for example, a coil loop, a resonant circuit, a rectifier, and the like may be added. For example, the battery gauge may measure a remaining battery life of the battery 296, a voltage, a current, or temperature during charging. The battery 296 may include a rechargeable battery and/or a solar battery.

The indicator 297 may display a specific state of the electronic device 201 or a part of it (for example, the processor 210), for example, a booting state, a message state, or a charging state. The motor 298 may convert an electric signal into a mechanical vibration, and cause a vibration or haptic effect. Although not shown, the electronic device 201 may include a processing device (for example, a GPU) for supporting a mobile TV. The processing device for supporting the mobile TV may process media data according to standards such as Digital Multimedia Broadcasting (DMB), Digital Video Broadcasting (DVB), or media flow.

Each of the above-described elements of the electronic device according to various embodiments of the present disclosure may be comprised of one or more components, and the names of the elements may vary according to the kind of the electronic device. The electronic device according to various embodiments may include at least one of the above-described elements, and some of the elements may be omitted or an additional element may be further included. In addition, some of the elements of the electronic device according to various embodiments may be combined into a single entity, and may perform the same functions as those of the elements before being combined.

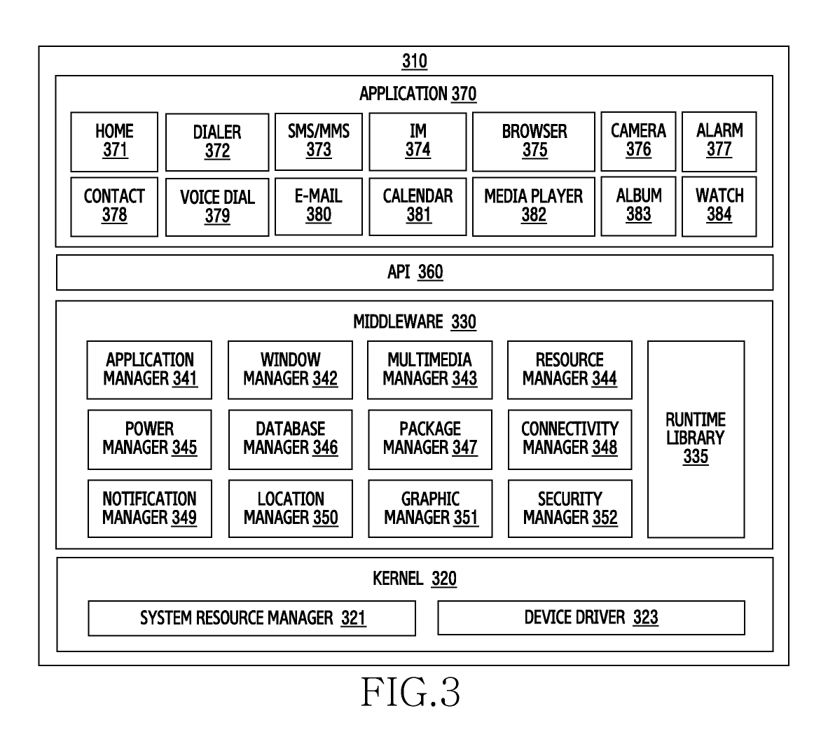

FIG. 3 is a block diagram of an example of a program module, according to various embodiments of the present disclosure. According to an exemplary embodiment, the program module 310 (for example, the program 140) may include an Operating System (OS) for controlling resources related to an electronic device (for example, the electronic device 101) and/or various applications (for example, the application 147) driven on the OS. For example, the OS may be Android, iOS, Windows, Symbian, Tizen, Bada, or the like.

Referring to FIG. 3, the program module 310 may include a kernel 320, middleware 330, an Application Programming Interface (API) 360, and/or an application 370. At least part of the program module 310 may be preloaded on the electronic device or downloaded from an external device (for example, the electronic device 102, 104, the server 106, or the like).

The kernel 320 (for example, the kernel 141) may include a system resource manager 321 and/or a device driver 323. The system resource manager 321 may control, allocate or collect the system resources. According to an exemplary embodiment, the system resource manager 321 may include a process manager, a memory manager, a file system manager, and the like. The device driver 323 may include a display driver, a camera driver, a Bluetooth driver, a shared memory driver, a Universal Serial Bus (USB) driver, a keypad driver, a WiFi driver, an audio driver, or an Inter-Process Communication (IPC) driver, for example.

The middleware 330 may provide functions which are commonly required by the application 370 or may provide various functions to the application 370 through the API 360 such that the application 370 can effectively use limited system resources in the electronic device. According to an exemplary embodiment, the middleware 330 (for example, the middleware 143) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, or a security manager 352.

For example, the runtime library 335 may include a library module which is used by a compiler to add a new function by using a programming language while the application 370 is executed. The runtime library 335 may perform functions related to input/output management, memory management, an arithmetic function, and the like.

The application manager 341 may manage a life cycle of at least one of the applications 370, for example. The window manager 342 may manage GUI resources used on a screen. The multimedia manager 343 grasps a format necessary for reproducing various media files and encodes or decodes the media files by using a Codec suited to the corresponding format. The resource manager 344 may manage resources such as a source code, a memory, or a storage space of at least one of the applications 370.

The power manager 345 operates along with a Basic Input/Output System (BIOS) to manage a battery or power and provide power information necessary for operations of the electronic device. The database manager 346 may generate, search, or change a database which is used in at least one of the applications 370. The package manager 347 may manage installing or updating an application which is distributed in the form of a package file.

The connectivity manager 348 may manage various wireless connections, such as WiFi, Bluetooth, and the like. The notification manager 349 may display or otherwise signal an event such as a message arrival, an appointment, a notification of proximity in such a manner that the event does not hinder the user. The location manager 350 may manage location information of the electronic device. The graphic manager 350 may manage a graphic effect to be provided to the user or a relevant user interface. Herein, the graphic manager 351 may include a dali graphic engine. The security manager 352 may provide an overall security function necessary for system security or user authentication. According to an exemplary embodiment, when the electronic device (for example, the electronic device 101) is equipped with a telephony function, the middleware 330 may further include a telephony manager to manage a speech or video telephony function of the electronic device.

The middleware 330 may include a middleware module to form a combination of the various functions of the above-described elements. The middleware 330 may provide a module which is customized according to a kind of OS to provide a distinct function. In addition, the middleware 330 may dynamically delete some of the existing elements or may add new elements.

The API 360 (for example, the API 145) is a set of API programming functions and may be provided as a different configuration according to an OS. For example, in the case of Android or iOS, a single API set may be provided for each platform. In the case of Tizen, two or more API sets may be provided for each platform.

The application 370 (for example, the application 147) may include one or more applications for providing functions, such as a home 371, a dialer 372, a Short Message Service (SMS)/Multimedia Messaging Service (MMS) 373, an Instant Message (IM) 374, a browser 375, a camera 376, an alarm 377, contacts 378, a voice dial 379, an email 380, a calendar 381, a media player 382, an album 383, or a clock 384, or health care (for example, measuring exercise or a blood sugar), or providing environment information (for example, information on atmospheric pressure, humidity, or temperature), for example.

According to an exemplary embodiment, the application 370 may include an application for supporting information exchange between the electronic device (for example, the electronic device 101) and an external electronic device (for example, the electronic devices 102, 104) (hereinafter, referred to as an “information exchange application” for the convenience of explanation). The information exchange application may include a notification relay application for relaying specific information to an external electronic device or a device management application for managing an external electronic device.

For example, the notification relay application may include a function of relaying notification information generated by other applications of the electronic device (for example, the SMS/MMS application, the email application, the health care application, the environment information application, and the like) to an external electronic device (for example, the electronic device 102, 104). In addition, the notification relay application may receive notification information from an external electronic device and may relay the same to the user.

For example, the device management application may manage (for example, install, delete or update) at least one function of an external electronic device (for example, the electronic device 104) communicating with the electronic device (for example, turning on/off an external electronic device (or some parts) or adjusting brightness (or resolution) of a display), an application operating in the external electronic device or a service provided by the external electronic device (for example, a calling service or a message service).

According to an exemplary embodiment, the application 370 may include an application (for example, a health care application of a mobile medical device) which is specified according to the attribute of the external electronic device (for example, the electronic device 102, 104). According to an exemplary embodiment, the application 370 may include an application received from an external electronic device (for example, the server 106 or the electronic devices 102, 104). According to an exemplary embodiment, the application 370 may include a preloaded application or a third party application which may be downloaded from a server. The names of the elements of the program module 310 according to the illustrated embodiments may be changed according to a kind of OS.

According to various embodiments, at least part of the program module 310 may be implemented by using software, firmware, hardware, or a combination of two or more of them. At least part of the program module 310 may be implemented (for example, executed) by a processor (for example, the processor 210). At least part of the program module 310 may include a module, a program, a routine, sets of instructions, or a process to perform one or more functions, for example.

The term “module” used in the various embodiments of the present disclosure refers to a unit including one of hardware, software, and firmware, or a combination of two or more of them, for example. For example, the “module” may be used interchangeably with terms like unit, logic, logical block, component or circuit. The “module” may be a minimum unit of an integrally configured part or a part of it. The “module” may be a minimum unit that performs one or more functions or a part of it. The “module” may be implemented mechanically or electronically. For example, the “module” may include at least one of an Application Specific Integrated Circuit (ASIC) chip, Field Programmable Gate Arrays (FPGAs), and a programmable logic device which perform any operation that is already well known or will be developed in the future.

At least part of the apparatus (for example, modules or functions) or method (for example, operations) according to various embodiments may be implemented by using instructions stored on a computer-readable storage media in the form of a programming module. When the instructions are executed by one or more processors (for example, the processor 120), the one or more processors may perform a function corresponding to the instructions. The computer-readable storage media may be the memory 130, for example.

Examples of the computer-readable recording medium include hard disks, floppy disks, magnetic media (for example, magnetic tapes), optical media (for example, Compact Disc Read-Only Memories (CD-ROMs), Digital Versatile Disc (DVDs), magneto-optical media (for example, floptical disks)), and hardware devices (for example, Read-Only Memories (ROMs), Random Access Memories (RAMs) and flash memories). Examples of the program commands include machine language codes created by a compiler and high-level language codes that can be executed by a computer by using an interpreter. The above-described hardware devices may be configured to operate as one or more software modules for performing operations of various exemplary embodiments of the present disclosure, and vice versa.

A module or programming module according to various embodiments may include one or more of the above-described elements, may omit some elements, or may further include additional other elements. The operations performed by the module, the programming module, or the other elements according to various embodiments may be performed serially, in parallel, repeatedly, or heuristically. In addition, some operation may be performed in different order or may be omitted, and additional other operations may be added.

In addition, the embodiments set forth in this document are suggested to explain and understand features disclosed therein, and do not limit the scope of the technical features set forth in this document. Therefore, the scope of this document should be construed as including all changes based on the technical idea of this document or other various embodiments.

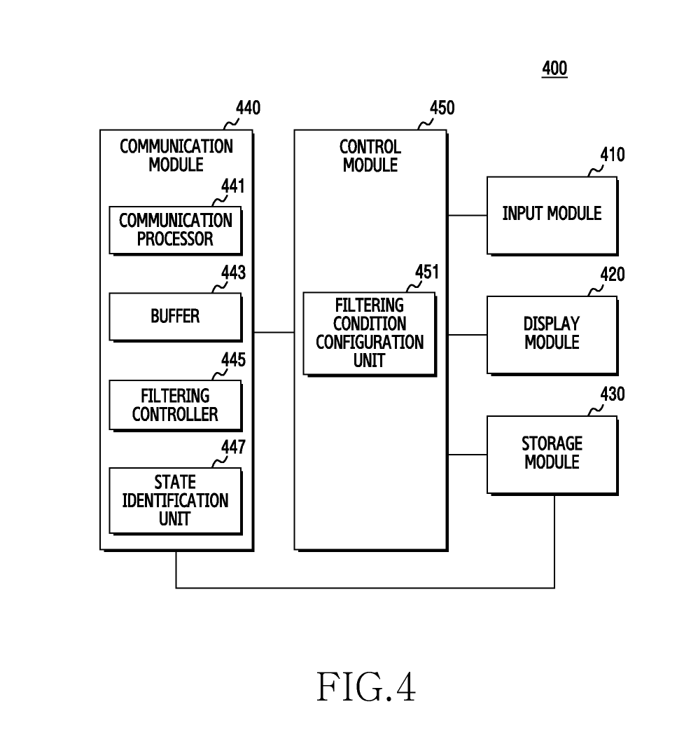

FIG. 4 is a block diagram of an example of an electronic device, according to various embodiments of the present disclosure.

Referring to FIG. 4, according to various embodiments of the present disclosure, an electronic device 400 may include an input module 410, a display module 420, a storage module 430, a communication module 440, and a control module 450.

The input module 410 generates input data in the electronic device 400. In this case, the input module 410 may generate the input data in response to a user input that is detected by the input module 410. In addition, the input module 410 may include at least one input means. The input module 410 may include a keypad, a dome switch, a physical button, a touch panel, a jog & shuttle, a sensor, and/or any other suitable type of device.

The display module 420 may output a user interface screen. The user interface screen may include at least one of an image and a text. The display module 420 may include a Liquid Crystal Display (LCD), a Light Emitting Diode (LED) display, an Organic LED (OLED) display, a Micro Electro Mechanical Systems (MEMS) display, and an electronic paper display. In addition, the display module 420 may be coupled to the input module 410, and may be implemented with a touch screen.

The storage module 430 may store operation programs of the electronic device 400. The storage module 430 may store a plurality of applications. At least one of the applications may be preloaded and then stored in the storage module 430. In addition, the storage module 430 may store a program for managing data in association with each application. Further, the storage module 430 may store data generated as a result of the execution of one or more applications. The storage module 430 may store a filtering condition in association with each application. The filtering condition may include one or more of a blocking condition for blocking data, a storing condition for storing data, and a passing condition for passing data. The storage module 403 may store any one of the blocking condition, the storing condition, and the passing condition in association with each application.

The communication module 440 performs communications on behalf of the electronic device 400. The communication module 440 may communicate with an external device (not shown) by using various communication schemes. The communication module 440 may perform at least one of wireless communication and wired communication. The communication module 440 may access at least one of a mobile communication network and a data communication network. Alternatively, the communication module 440 may perform short-distance communication. For example, the external device may include an electronic device, a base station, a server, and a satellite. In addition, the communication scheme may include Long Term (LTE), Wideband Code Division Multiple Access (WDCMA), Global System for Mobile Communications (GSM), Wireless Fidelity (WiFi), Bluetooth, and Near Field Communications (NFC). The communication module 440 may include a communication processor 441, a buffer 443, a filtering controller 445, and a state identification unit 447.

The communication processor 441 may transmit/receive and process data in association with at least one of the applications.

The buffer 443 may temporarily store a part of the received data.

The filtering controller 445 may filter the data. The filtering controller 445 may filter the data according to a filtering condition. When the data is received through the communication processor 441, the filtering controller 445 may select any one of the applications in association with the data. In addition, the filtering controller 445 may identify the filtering condition in association with the application. If a blocking condition is configured as the filtering condition, the filtering controller 445 may block or delete the received data. Alternatively, if a storing condition is configured as the filtering condition, the filtering controller 445 may store the data in the buffer 443 or the storage module 430. Alternatively, if a passing condition is configured as the filtering condition, the filtering controller 445 may allow the data to be delivered to the control module 450.

The state identification unit 447 may identify a state of the electronic device 400. In some implementations, identifying the state of the electronic device 400 may include identifying one or more of the current power mode of the electronic device 400 and the current operation mode of the electronic device 400. The power mode of the electronic device 400 may include a normal power mode and a low power mode. In addition, the operation mode of the electronic device 400 may include a sleep mode and an active mode. The current operation mode of the electronic device 400 may be determined according to the current operational state of the display module 420 or the control module 450 (e.g., based on whether at least one of the display module 420 and./or control module 450 is active).

The control module 450 may control an overall operation of the electronic device 400. The control module 450 may execute various applications and/or operations. In addition, the control module 450 may process the applications. The control module 450 may download at least one of a plurality of applications. The control module 450 may manage data generated during the operation of programs that are executed. When data is received from the communication module 440, the control module 450 may drive any one of the applications to process the data. The control module 450 may execute a filtering condition configuration unit 451.

The filtering condition configuration unit 451 may configure the filtering condition in association with each application. When the filtering condition is input through the input module 410, the filtering condition configuration unit 451 may store an indication of the filtering condition in the storage module 430. The filtering condition configuration unit 451 may determine whether any one of the blocking condition, the storing condition, and the passing condition is satisfied.

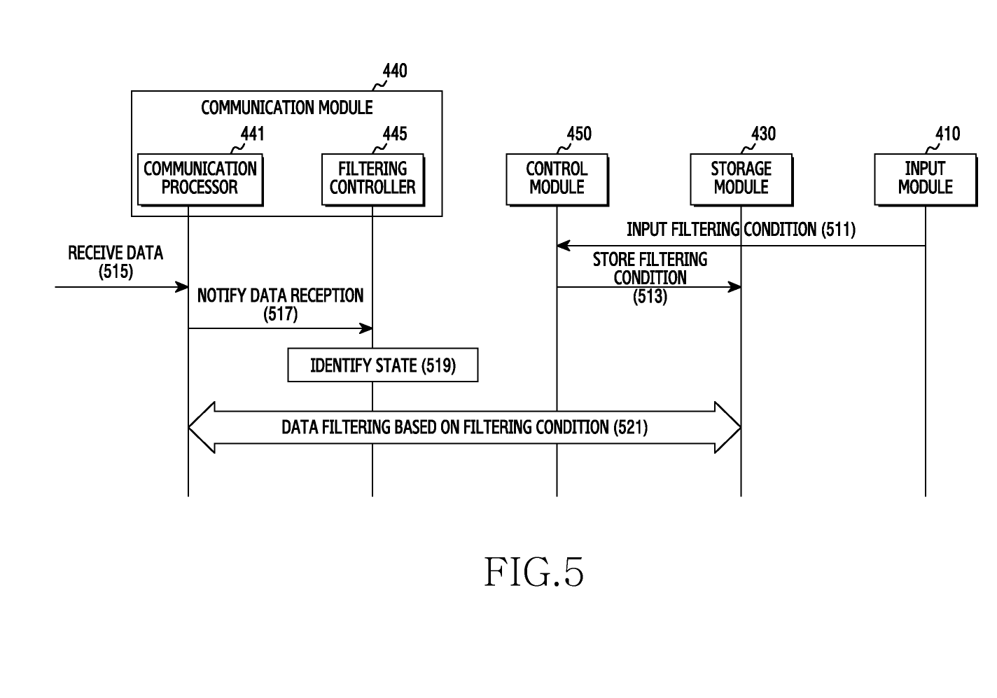

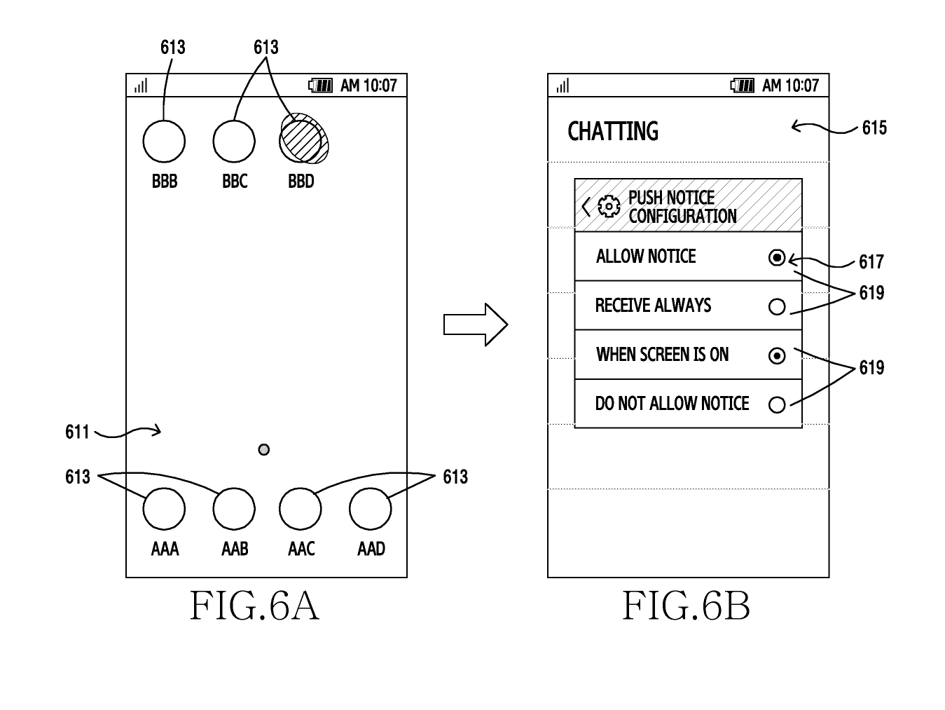

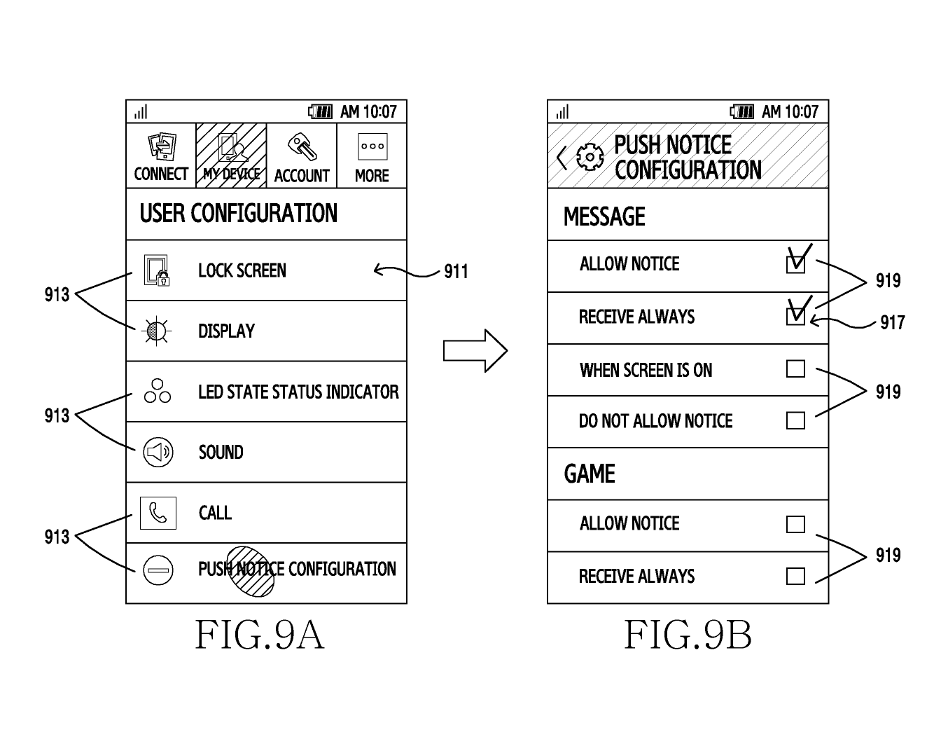

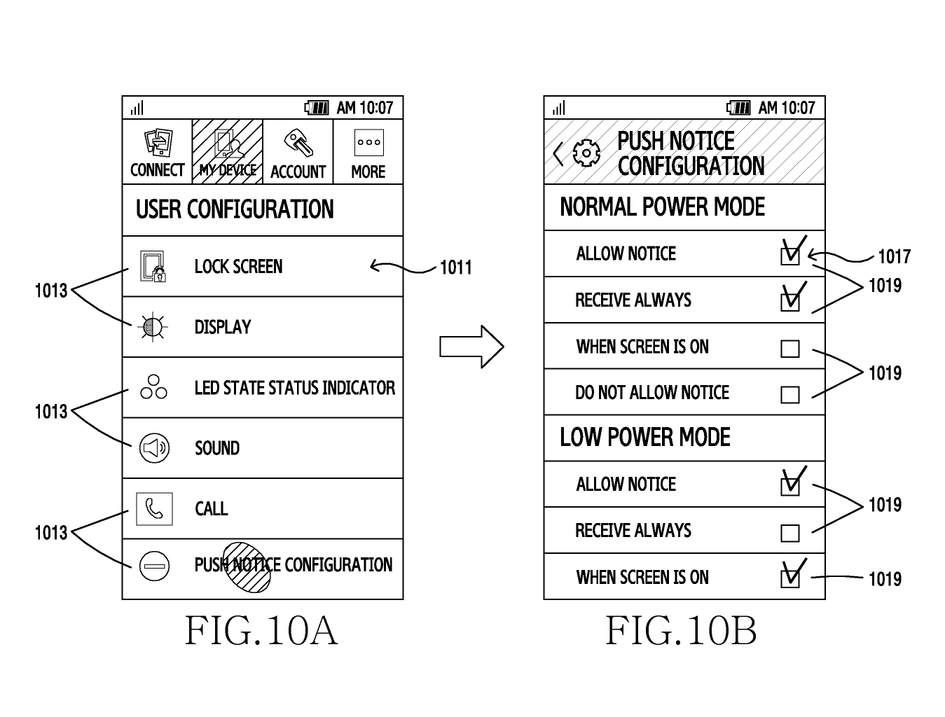

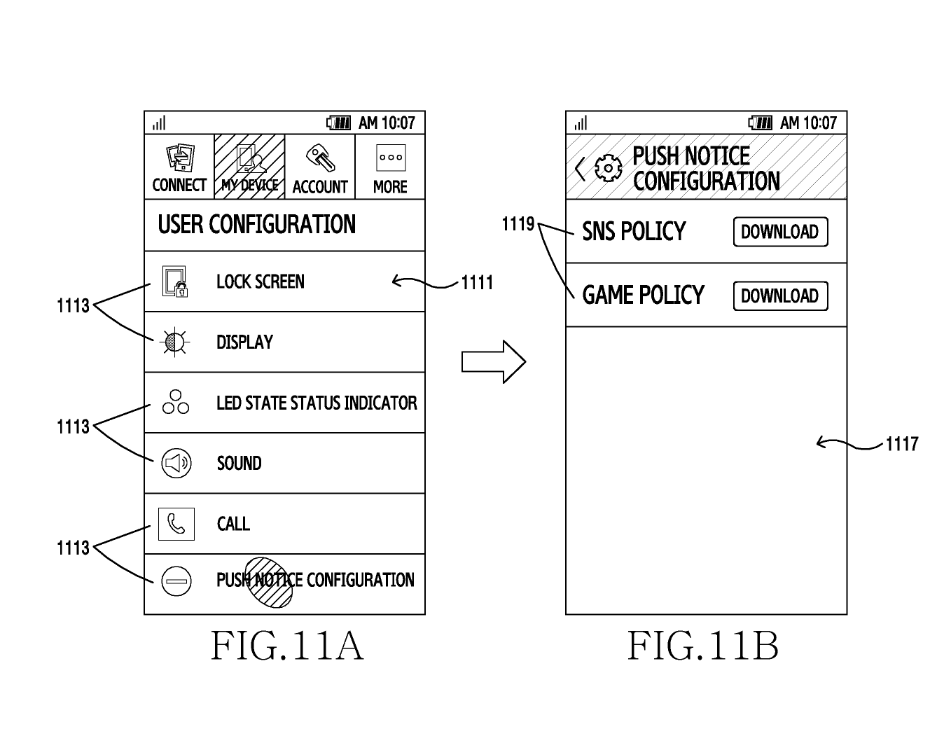

FIG. 5 is a sequence diagram of an example of a process, according to various embodiments of the present disclosure. In addition, FIGS. 6A-6B, FIGS. 7A-7B, FIGS. 8A-B, FIGS. 9A-B, FIGS. 10A-B, and FIGS. 11A-B illustrate examples of a screen for explaining an operation of configuring a filtering condition in FIG. 5.

Referring to FIG. 5, the input module 410 may input the filtering condition in operation 511. The control module 450 may have a plurality of applications pre-stored therein. The input module 410 may provide the filtering condition in association with any one of the applications. The control module 450 may store an indication of the filtering condition in the storage module 430 in operation 513. The filtering condition configuration unit 451 may configure the filtering condition in association with any one of the applications. For example, the filtering condition configuration unit 451 may initially configure the filtering condition and may change the filtering condition.

According to one exemplary embodiment, the filtering condition configuration unit 451 may initially configure the filtering condition individually with respect to the applications. When each application is initially executed, the filtering condition configuration unit 451 may configure the filtering condition. For example, as shown in FIG. 6A, the filtering condition configuration unit 451 may display icons 613 of the applications on a background screen 611 through the display module 420. When any one of the icons 613 is selected through the input module 410, as shown in FIG. 6B, the filtering condition configuration unit 451 may display a processing screen 615 of the application through the display module 420. In addition, when the application is initially driven, the filtering condition configuration unit 451 may display a configuration window 617 for configuring the filtering condition of the application through the display module 420. The filtering condition configuration unit 451 may display selection items 619 in the configuration window 617. Further, when at least one of the selection items 619 is selected through the input module 410, the filtering condition configuration unit 451 may configure the filtering condition of the application.

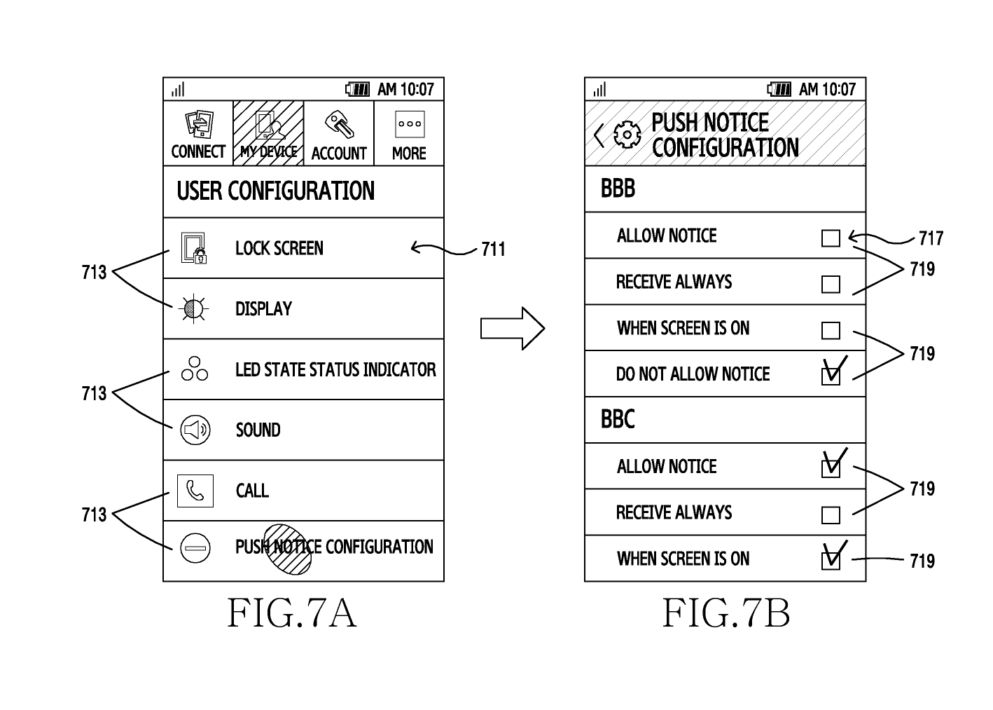

According to one exemplary embodiment, the filtering condition configuration unit 451 may initially configure and change the filtering condition individually with respect to the applications. The filtering condition configuration unit 451 may present the configuration menu in order to permit the user to select a desired filtering condition. For example, if the configuration menu is presented, as shown in FIG. 7A, the filtering condition configuration unit 451 may display a configuration screen 711 through the display module 420. The filtering condition configuration unit 451 may display various configuration items 713 in the configuration screen 711. When any one of the configuration items 713 is selected through the input module 410, as shown in FIG. 7B, the filtering condition configuration unit 451 may display a configuration window 717 for configuring the filtering condition of applications on the display module 420. The filtering condition configuration unit 451 may display selection items 719 in association with each application in the configuration window 717. In addition, when at least one of the selection items 719 is selected through the input module 410, the filtering condition configuration unit 451 may configure the filtering condition of the applications.

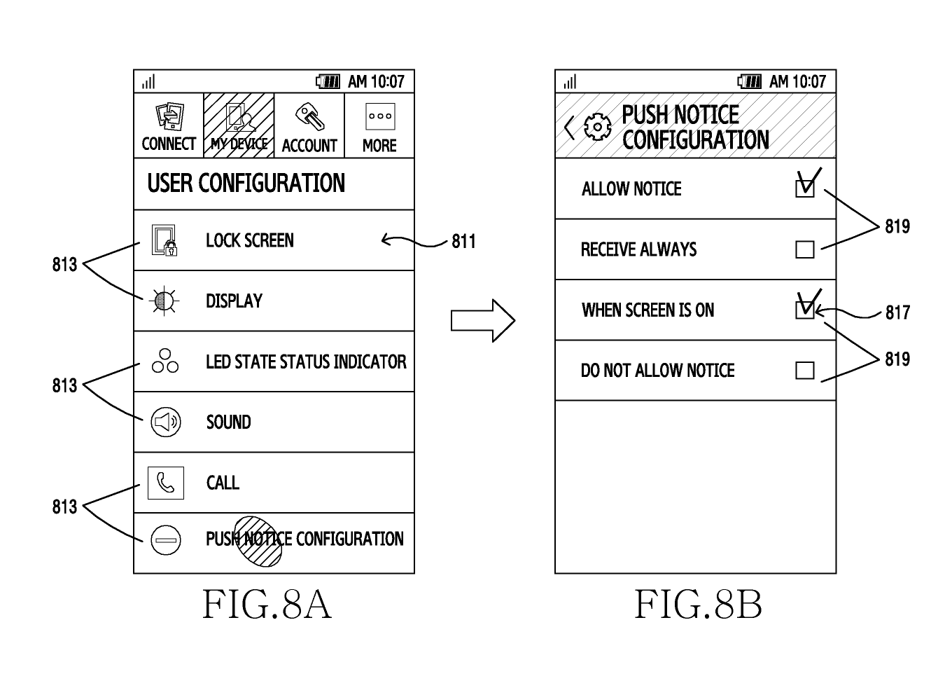

According to one exemplary embodiment, the filtering condition configuration unit 451 may initially configure and change the filtering condition collectively with respective to the applications. The filtering condition configuration unit 451 may present the configuration menu in order to permit the user to select a desired filtering condition. For example, if the configuration menu is presented, as shown in FIG. 8A, the filtering condition configuration unit 451 may display a configuration screen 811 through the display module 420. The filtering condition configuration unit 451 may display various configuration items 813 in the configuration screen 811. When any one of the configuration items 813 for configuring the filtering condition is selected through the input module 410, as shown in FIG. 8B, the filtering condition configuration unit 451 may display a configuration window 817 for configuring the filtering condition of applications through the display module 420. The filtering condition configuration unit 451 may display selection items 819 in the configuration window 817. In addition, when at least one of the selection items 819 is selected through the input module 410, the filtering condition configuration unit 451 may configure the filtering condition of the applications.

According to one exemplary embodiment, the filtering condition configuration unit 451 may divide the applications into one or more groups, and may initially configure and change the filtering condition individually with respect to the groups. The filtering condition configuration unit 451 may present the configuration menu in order to permit the user to select a desired filtering condition. For example, if the configuration menu is presented, as shown in FIG. 9A, the filtering condition configuration unit 451 may display a configuration screen 911 through the display module 420. The filtering condition configuration unit 451 may display various configuration items 913 in the configuration screen 911. When any one of the configuration items 913 for configuring the filtering condition is selected through the input module 410, as shown in FIG. 9B, the filtering condition configuration unit 451 may display a configuration window 917 for configuring the filtering condition of applications through the display module 420. The filtering condition configuration unit 451 may divide the applications into a plurality of groups, and may display selection items 919 in association with each group in the configuration window 917. In addition, when at least one of the selection items 919 is selected through the input module 410 in association with each group, the filtering condition configuration unit 451 may configure the filtering condition of the applications.

According to one exemplary embodiment, the filtering condition configuration unit 451 may initially configure and change the filtering condition with respect to the applications according to a power mode of the electronic device 400. The filtering condition configuration unit 451 may present the configuration menu in order to permit the user to select a desired filtering condition. For example, if the configuration menu is presented, as shown in FIG. 10A, the filtering condition configuration unit 451 may display a configuration screen 1011 through the display module 420. The filtering condition configuration unit 451 may display various configuration items 1013 in the configuration screen 1011. When any one of the configuration items 1013 for configuring the filtering condition is selected through the input module 410, as shown in FIG. 10B, the filtering condition configuration unit 451 may display a configuration window 1017 for configuring the filtering condition of applications. The filtering condition configuration unit 451 may display, in the configuration window 1017, respective selection items 1019 that are associated with each power mode. In addition, when one of the selection items 1019 that is associated with a particular group is selected through the input module 410, the filtering condition configuration unit 451 may associate the filtering condition corresponding to the selection item with any of the applications in the group.

Although in the above examples the filtering condition is specified manually, in some implementations the filtering condition may be downloaded from a remote source. The filtering condition configuration unit 451 may present the configuration menu in order to permit the user to download a particular filtering condition. For example, if the configuration menu is presented, as shown in FIG. 11A, the filtering condition configuration unit 451 may display a configuration screen 1111 through the display module 420. The filtering condition configuration unit 451 may display various configuration items 1113 in the configuration screen 1111. When any one of the configuration items 1113 for configuring the filtering condition is selected via the input module 410, as shown in FIG. 11B, the filtering condition configuration unit 451 may display a configuration window 1117 for configuring the filtering condition of applications. The filtering condition configuration unit 451 may display at least one selection item 1119 for downloading the filtering condition in the configuration window 1117. In addition, when the selection item 1119 is selected through the input module, the filtering condition configuration unit 451 may configure the filtering condition by downloading at least one of the filtering conditions of the applications.

For example, the filtering condition configuration unit 451 may configure the filtering condition as shown in Table 1 below. According to aspects of the disclosure, the indication of a given filtering condition may include one or more of identification information, an indication of whether reporting of data is allowed, and an indication of a data delivery scheme in association with each application. For example, the indication whether the reporting is allowed may specify that the reporting of data is allowed or not allowed. When the reporting of data is allowed, the data is forwarded to one or more applications associated with the data. When the reporting of the data is not allowed, the data may be blocked. As another example, the indication of the data delivery scheme may specify the immediacy with which the data is to be delivered to one or more corresponding applications. The indication of the data delivery scheme may specify that the data is to be delivered immediately or association with a specific event after storing the data. For instance, the indication of the data delivery scheme may require the data to be temporarily stored in a buffer until a predetermined event occurs (e.g., the device wakes up).

TABLE 1

| | | | a data |
|---|---|---|---|
| | identification | whether reporting of | delivery |
| application | information | data is allowed | scheme |
| BBB | 211.XXX.XXX.XXX | Reporting is allowed | Immediate |
| | | | reporting |
| BBC | 172.XXX.XXX.XXX | Reporting is allowed | Reporting |
| | | | after |
| | | | storing |
| BBD | 162.XXX.XXX.XXX | Reporting is not | — |
| | | allowed | |
| — | — | — | — |
| — | — | — | — |
| — | — | — | — |

When data is received in operation 515, the communication processor 441 may detect the data reception. The communication processor 441 may include identification information corresponding to an application associated with the data. The data may include the identification information of the application in association with any one of the applications of the storage module 430. The data may be transmitted from an application server for operating the application (e.g., a backend server associated with the application). In some implementations, the data may be transmitted by using push notification service that is provided by the application server. Further, the identification information associated with the application may include an identifier corresponding to the application server. The communication processor 441 may transmit a response message by using the identification information of the application. The communication processor 441 may transmit the response message to the application server, and may transmit the response message by including the identification information of the application. For example, the communication processor 441 may transmit an ‘ACK’ signal as a positive acknowledge message.

In operation 517, the communication processor 441 may notify the filtering controller 445 that the data is received. The communication processor 441 may deliver the identification information of the application to the filtering controller 445.

In operation 519, the filtering controller 445 may identify a state of the electronic device 400. The filtering controller 445 may identify the state of the electronic device 400 through the state identification unit 447. The state of the electronic device 400 may include a current power mode and a current operation mode of the electronic device 400. The current power mode of the electronic device 400 may include a normal power mode and a low power mode. In addition, the current operation mode of the electronic device 400 may include a sleep mode and an active mode. The current operation mode of the electronic device 400 may be determined according to whether the display module 420 or the control module 450 is driven.

In operation 521, the filtering controller 445 may filter the data according to the filtering condition. When the data is received through the communication processor 441, the filtering controller 445 may identify one or more applications that are associated with the data. In addition, the filtering controller 445 may identify a respective filtering condition that is associated with one or more of the applications. If a blocking condition is configured as the filtering condition, the filtering controller 445 may block or delete the received data. Alternatively, if a storing condition is configured as the filtering condition, the filtering controller 445 may store the data in the buffer 443 or the storage module 430. Alternatively, if a passing condition is configured as the filtering condition, the filtering controller 445 may allow the data to be delivered to the control module 450. According to various embodiments of the present disclosure, the electronic device 400 may process the received data differently depending on the current power mode (e.g., the normal power mode, the low power mode).

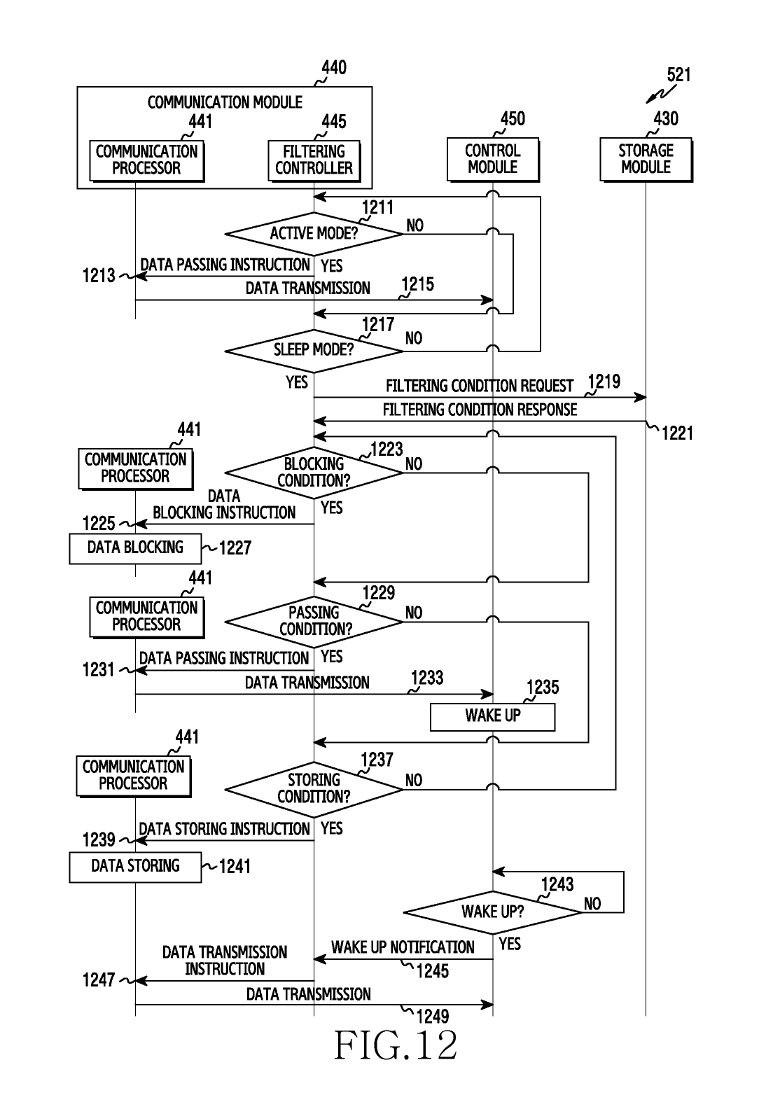

FIG. 12 is a flowchart of an example of a process, according to various embodiments of the present disclosure.

Referring to FIG. 12, in operation 1211, the filtering controller 445 may determine whether the current operation mode of the electronic device 400 is an active mode. If it is determined in operation 1211 that the current operation mode of the electronic device 400 is the active mode, the filtering controller 445 may deliver a data passing instruction to the communication processor 441 in operation 1213. Upon receiving the data passing instruction, the communication processor 441 may deliver the data passing instruction to the control module 450 in operation 1215.

If it is determined in operation 1211 that the current operation mode of the electronic device 400 is not the active mode, the filtering controller 445 may determine whether the current operation mode of the electronic device 400 is a sleep mode in operation 1217. If it is determined in operation 1217 that the current operation mode of the electronic device 400 is the sleep mode, the filtering controller 445 may retrieve a filtering condition stored in the storage module 430. For example, the filtering controller 445 may request the filtering condition from the storage module 430 in operation 1219. Additionally or alternatively, the filtering controller 445 may deliver to the storage module 430 identification information associated with the application. When the filtering condition is requested, the storage module 430 may respond to the filtering controller 445 in operation 1221. The storage module 430 may deliver the filtering condition to the filtering controller 445 in association with the identification information of the application.

Upon receiving the filtering condition, the filtering controller 445 may determine whether the filtering condition includes a blocking condition in operation 1223. For example, the filtering controller 445 may determine whether the filtering condition provides that reporting of received data is not allowed (e.g., ‘Reporting is not allowed’). If it is determined in operation 1223 that the filtering condition includes a blocking condition, the filtering controller 445 may deliver a data blocking instruction to the communication processor 441 in operation 1225. Upon receiving the data blocking instruction, the communication processor 441 may block data in operation 1227. That is, the communication processor 441 may delete the data instead of delivering the data to the control module 450.

If it is determined in operation 1223 that the filtering condition does not include a blocking condition, the filtering controller 445 may determine whether the filtering condition includes a passing condition, in operation 1229. For example, the filtering controller 445 may determine whether the filtering condition permits ‘Immediate reporting’ of received data. If it is determined in operation 1229 that the filtering condition includes a passing condition, the filtering controller 445 may deliver a data passing instruction to the communication processor 441 in operation 1231. Upon receiving the data passing instruction, the communication processor 441 may transmit data to the control module 450 in operation 1233. Upon receiving the data, the control module 450 may wake up in operation 1235. For example, the controller module 450 may change the current operation mode of the electronic device 400 from the sleep mode to the active mode.

If it is determined in operation 1229 that the filtering condition does not include a passing condition, the filtering controller 445 may determine whether the filtering condition includes a storing condition, in operation 1237. For example, the filtering controller 445 may determine whether the filtering condition provides that data should be reported after being temporarily stored in the memory of the electronic device (e.g., ‘Reporting after storing’). If it is determined in operation 1237 that the filtering condition does not include a storing condition, the filtering controller 445 may deliver a data storing instruction to the communication processor 441 in operation 1239. Upon receiving the data storing instruction, the communication processor 441 may store the data in the buffer 443 temporarily or in the storage module 430 in operation 1241. If the electronic device 400 wakes up in operation 1243, the control module 450 may detect the electronic device has woken up. For example, if the display module 420 is on or if a touch is detected through the input module 410 in a touch screen, the electronic device 400 may wake up. For example, the controller module 450 may change the current operation mode of the electronic device 400 from the sleep mode to the active mode. In operation 1245, the control module 450 may signal the wake-up of the electronic device 400 to the filtering controller 445. In operation 1247, the filtering controller 445 may deliver a data transmission instruction to the communication processor 441. Upon receiving the data transmission instruction, in operation 1249, the communication processor 441 may transmit the data stored in the control module 450.

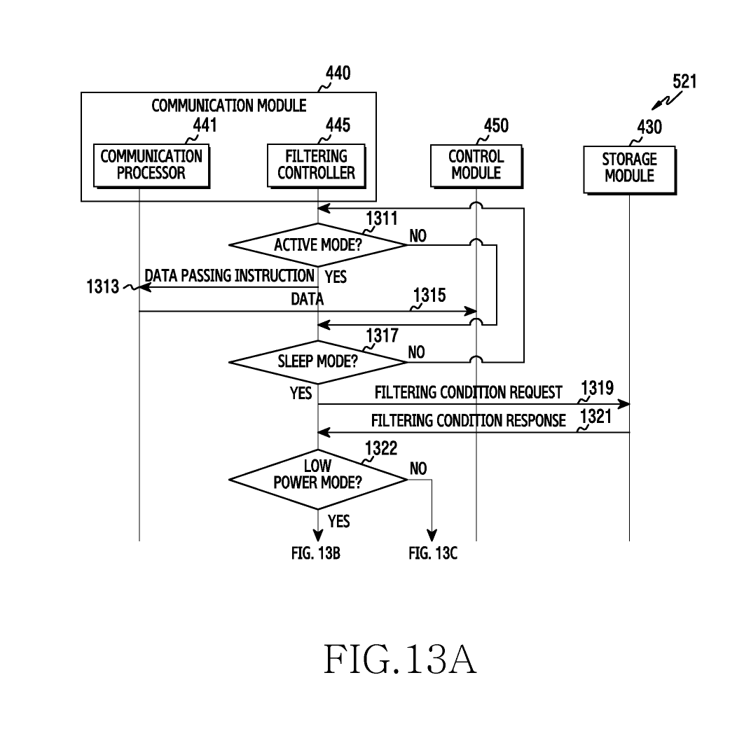

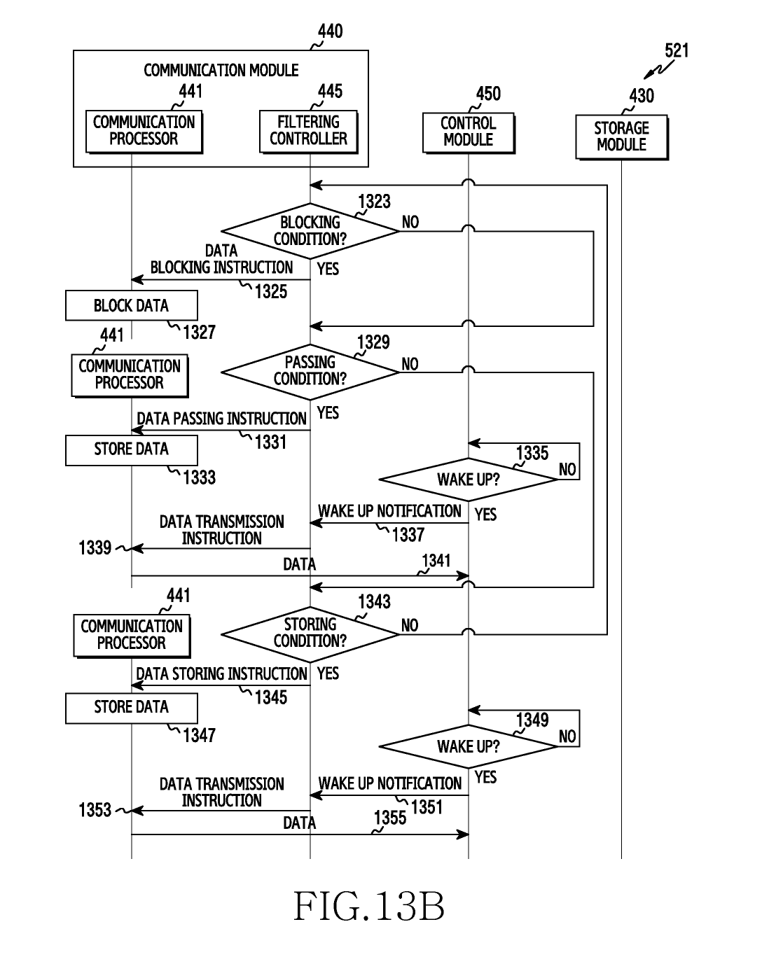

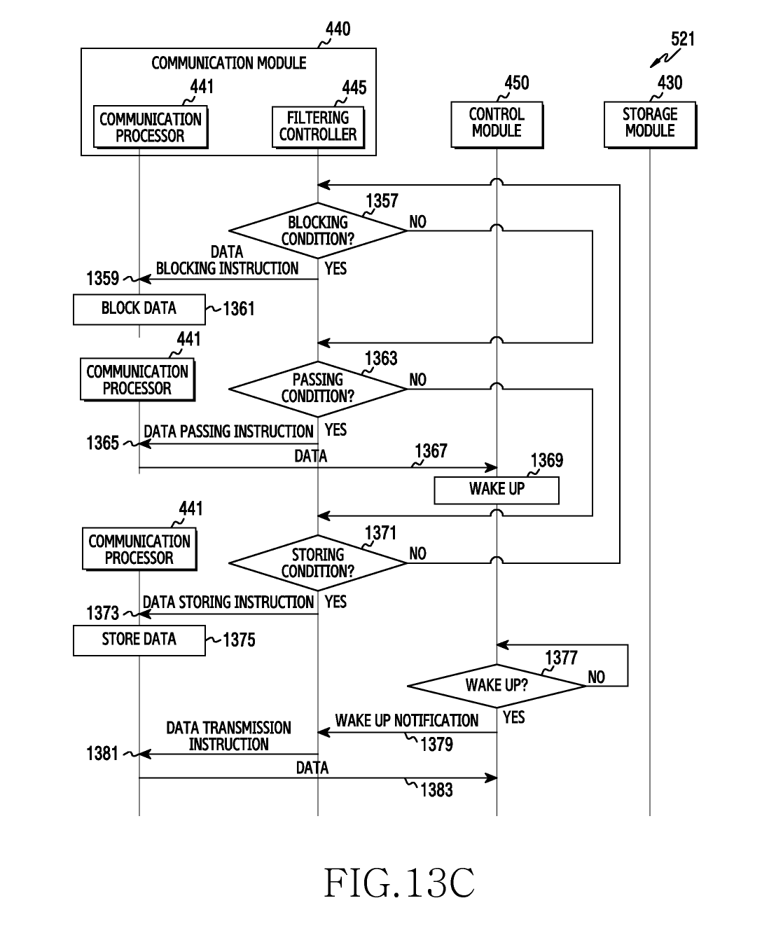

FIGS. 13A-C are flowcharts illustrating an example of a process for performing a data processing operation, according to various embodiments of the present disclosure.

According to various embodiments of the present disclosure of the present disclosure, the electronic device 400 may operate differently on the basis of the power mode. For example, if the power mode of the electronic device 400 is a normal power mode, the electronic device 400 may operate according to a configured filtering condition. If the power mode of the electronic device 400 is a low power mode, the electronic device 400 may apply a blocking condition to received data irrespective of the configured filtering condition. Alternatively, if the power mode of the electronic device 400 is the low power mode, the electronic device 400 may apply a passing condition among the configured filtering conditions in the same manner of applying a storing condition.

Referring to FIG. 13A, in operation 1311, the filtering controller 445 may determine whether the current operation mode of the electronic device 400 is an active mode. If it is determined in operation 1311 that the current operation mode of the electronic device 400 is the active mode, the filtering controller 445 may deliver a data passing instruction to the communication processor 441 in operation 1313. Upon receiving the data passing instruction, the communication processor 441 may deliver it to the control module 450 in operation 1315.

If it is determined in operation 1311 that the current operation mode of the electronic device 400 is not the active mode, the filtering controller 445 may determine whether the current operation mode of the electronic device 400 is a sleep mode in operation 1317. If it is determined in operation 1317 that the current operation mode of the electronic device 400 is the sleep mode, the filtering controller 445 may retrieve a filtering condition stored in the storage module 430. For example, the filtering controller 445 may request the filtering condition from the storage module 430 in operation 1319. The filtering controller 445 may deliver identification information of the application to the storage module 430. When the filtering condition is requested, the storage module 430 may respond to the filtering controller 445 in operation 1321. The storage module 430 may deliver the filtering condition to the filtering controller 445 in association with the identification information of the application. Upon receiving the filtering condition, the filtering controller 445 may determine whether the current power mode of the electronic device 400 is a low power mode, in operation 1322.

If it is determined in operation 1322 that the power mode of the electronic device 400 is the low power mode, an operation of FIG. 13B may be performed.

FIG. 13B is a flowchart illustrating a process of performing a data processing operation in case of a low lower mode. According to various embodiments of the present disclosure, the filtering controller 445 may determine whether the filtering condition includes a blocking condition, in operation 1323. If it is determined in operation 1323 that the filtering condition includes a blocking condition, the filtering controller 445 may deliver a data blocking instruction to the communication processor 441 in operation 1325. For example, the filtering controller 445 may determine whether the filtering condition provides that reporting of received data is not allowed (e.g., ‘Reporting is not allowed’). Upon receiving the data blocking instruction, the communication processor 441 may block data in operation 1327. That is, the communication processor 441 may delete the data instead of delivering the data to the control module 450.

If it is determined in operation 1323 that the filtering condition does not include a blocking condition, the filtering controller 445 may determine whether the filtering condition includes a passing condition, in operation 1329. For example, the filtering controller 445 may determine whether the filtering condition permits ‘Immediate reporting’ of received data. If it is determined in operation 1329 that the filtering condition includes a passing condition, the filtering controller 445 may deliver a data storing instruction to the communication processor 441 in operation 1331. Upon receiving the data storing instruction, the communication processor 441 may store the data in the buffer 443 temporarily in operation 1333. If the electronic device 400 wakes up in operation 1335, the control module 450 may detect that the electronic device has woken up. If the display module 420 is on or if a touch is detected through the input module 410, the electronic device 400 may wake up. For example, in some implementations, the controller module 450 may change the current operation mode of the electronic device 400 from the sleep mode to the active mode. In operation 1337, the control module 450 may notify—the filtering controller 445 that the electronic device has woken up. In operation 1339, the filtering controller 445 may deliver a data transmission instruction to the communication processor 441. Upon receiving the data transmission instruction, in operation 1341, the communication processor 441 may transmit the data stored in the buffer 443 to the control module 450.

If it is determined in operation 1329 that the filtering condition does not include a passing condition, the filtering controller 445 may determine whether the filtering condition includes a storing condition, in operation 1343. For example, the filtering controller 445 may determine whether the filtering condition provides that received data should be reported after it is stored (e.g., ‘Reporting after storing’). If it is determined in operation 1343 that the filtering condition does not include a storing condition, the filtering controller 445 may deliver a data storing instruction to the communication processor 441 in operation 1345. Upon receiving the data storing instruction, the communication processor 441 may store the data in the buffer 443 temporarily in operation 1347. If the electronic device 400 wakes up in operation 1349, the control module 450 may detect that the electronic device has woken up. For example, if the display module 420 is on or if a touch is detected through the input module 410, the electronic device 400 may wake up. That is, the controller module 450 may change the current operation mode of the electronic device 400 from the sleep mode to the active mode. In operation 1351, the control module 450 may signal the wake-up of the electronic device 400 to the filtering controller 445. In operation 1353, the filtering controller 445 may deliver a data transmission instruction to the communication processor 441. Upon receiving the data transmission instruction, in operation 1355, the communication processor 441 may transmit the data stored in the buffer 443 to the control module 450.

If it is determined in operation 1322 that the power mode of the electronic device 400 is the low power mode, the filtering controller 445 may determine whether the filtering condition includes a blocking condition, in operation 1357. As illustrated in FIG. 13C, if it is determined in operation 1357 that the filtering condition includes a blocking condition, the filtering controller 445 may deliver a data blocking instruction to the communication processor 441 in operation 1359. For example, the filtering controller 445 may determine whether the filtering condition provides that reporting of received data is not allowed (e.g., ‘Reporting is not allowed’). Upon receiving the data blocking instruction, the communication processor 441 may block data in operation 1361. For example, the communication processor 441 may delete the data instead of delivering the data to the control module 450.

If it is determined in operation 1357 that the filtering condition does not include a blocking condition, the filtering controller 445 may determine whether the filtering condition includes a passing condition, in operation 1363. For example, the filtering controller 445 may determine whether the filtering condition provides that received data should be reported immediately (e.g., ‘Immediate reporting’). If it is determined in operation 1363 that the filtering condition includes a passing condition, the filtering controller 445 may deliver a data passing instruction to the communication processor 441 in operation 1365. Upon receiving the data passing instruction, the communication processor 441 may deliver the data passing instruction to the control module 450 in operation 1367. Upon receiving the data, the control module 450 may wake up in operation 1369. For example, the controller module 450 may change the current operation mode of the electronic device 400 from the sleep mode to the active mode.

If it is determined in operation 1363 that the filtering condition does not include a passing condition, the filtering controller 445 may determine whether the filtering condition includes a storing condition, in operation 1371. For example, the filtering controller 445 may determine whether the filtering condition provides that the received data should be reported after it is stored in the memory of the electronic device (e.g., ‘Reporting after storing’). If it is determined in operation 1371 that the filtering condition does not include a storing condition, the filtering controller 445 may deliver a data storing instruction to the communication processor 441 in operation 1373. Upon receiving the data storing instruction, the communication processor 441 may store the data in the buffer 443 temporarily in operation 1375. If the electronic device 400 wakes up in operation 1377, the control module 450 may detect this. If the display module 420 is on or if a touch is detected through the input module 410 in a touch screen, the electronic device 400 may wake up. That is, the controller module 450 may change the current operation mode of the electronic device 400 from the sleep mode to the active mode. In operation 1379, the control module 450 may signal the wake-up of the electronic device 400 to the filtering controller 445. In operation 1381, the filtering controller 445 may deliver a data transmission instruction to the communication processor 441. Upon receiving the data transmission instruction, in operation 1383, the communication processor 441 may transmit the data stored in the buffer 443 to the control module 450.

According to various embodiments of the present disclosure of the present disclosure, a time of maintaining a sleep mode can be extended in the electronic device 400 by filtering data on the basis of a filtering condition. That is, even if the data is received in the sleep mode, the electronic device 400 can maintain the sleep mode without waking up.

FIGS. 1-13C are provided as an example only. At least some of the operations discussed with respect to these figures can be performed concurrently, performed in different order, and/or altogether omitted. It will be understood that the provision of the examples described herein, as well as clauses phrased as “such as,” “e.g.”, “including”, “in some aspects,” “in some implementations,” and the like should not be interpreted as limiting the claimed subject matter to the specific examples.

The above-described aspects of the present disclosure can be implemented in hardware, firmware or via the execution of software or computer code that can be stored in a recording medium such as a CD-ROM, a Digital, Versatile Disc (DVD), a magnetic tape, a RAM, a floppy disk, a hard disk, or a magneto-optical disk or computer code downloaded over a network originally stored on a remote recording medium or a non-transitory machine-readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

While various embodiments of the present disclosure have been shown and described with reference to certain preferred embodiments thereof, it will be understood by those skilled in the art that various changes in form and details may be made therein without departing from the spirit and scope of the embodiments of the present disclosure as defined by the appended claims. Therefore, the scope of the various embodiments of the present disclosure is defined not by the detailed description of the various embodiments of the present disclosure but by the appended claims, and all differences within the scope will be construed as being included in the various embodiments of the present disclosure.

What is claimed is:

1. A method of an electronic device comprising:
receiving, by a communication module of the electronic device, data from outside of the electronic device;
identifying, by the communication module, a filtering condition associated with the data;
detecting, by the communication module, whether the filtering condition is satisfied; and
forwarding, by the communication module, the data to inside of the electronic device in response to detecting that the filtering condition is satisfied.

2. The method of claim 1, further comprising:
when the filtering condition is not satisfied, temporarily storing, by the communication module, the data until the filtering condition is satisfied.

3. The method of claim 1, further comprising:
storing, by the communication module, an indication of the filtering condition.

4. The method of claim 1,
wherein the filtering condition is identified based on a power mode of the electronic device, and
wherein the power mode includes at least one of a normal-power mode and a low-power mode.

5. The method of claim 1, wherein the filtering condition includes at least one of a condition for blocking the data, and a condition for forwarding the data.

6. The method of claim 1, wherein the filtering condition is that the electronic device wakes up.

7. The method of claim 1, wherein the filtering condition is application-specific.

8. The method of claim 1, further comprising:
changing the filtering condition.

9. The method of claim 1, further comprising:
displaying a User Interface (UI) for inputting the filtering condition;
detecting, via the UI, an input specifying the filtering condition; and
storing in a memory of the electronic device an indication of the filtering condition.

10. The method of claim 9, wherein
the UI includes a menu including a plurality of menu options, each menu option corresponding to a different filtering condition, and
the input specifying the filtering condition includes an input selecting one or more of the menu options.

11. The method of claim 1, wherein forwarding the data comprises:
waking up the electronic device when the electronic device is in a sleep mode.

12. An electronic device comprising:
at least one processor; and
a communication module operatively coupled to a memory, configured to:
receive data from outside of the electronic device,
identify a filtering condition associated with the data,
detect whether the filtering condition is satisfied, and
forward the data to the at least one processor in response to detecting that the filtering condition is satisfied.

13. The electronic device of claim 12, wherein the communication module is further configured to:
when the filtering condition is not satisfied, temporarily store the data until the filtering condition is satisfied

14. The electronic device of claim 12,
wherein the filtering condition is identified based on a power mode of the electronic device, and
wherein the power mode includes at least one of a normal-power mode and a low-power mode.

15. The electronic device of claim 12, wherein the filtering condition includes at least one of a condition for blocking the data, and a condition for forwarding the data.

16. The electronic device of claim 12, wherein the filtering condition is application-specific.

17. The electronic device of claim 12, wherein the communication module is further configured to change the filtering condition.

18. The electronic device of claim 12, wherein the communication module is further configured to:
display a User Interface (UI) for inputting the filtering condition,
detect an input received via the UI that specifies the filtering condition, and
store the filtering condition.

19. The electronic device of claim 18,
wherein the UI includes a menu including a plurality of menu options, each menu option corresponding to a different filtering condition, and
wherein the input that specifies the filtering condition includes an input selecting one or more of the menu options.

20. The electronic device of claim 15, wherein the communication module is further configured to:
wake up the electronic device to forward the data when the electronic device is in a sleep mode.
